(19) United States
(12) Patent Application Publication
(10) Pub. No.: US 2011/0119128 A1
(43) Pub. Date: May 19, 2011

(54) Advertising Exchange System to Share Online Audiences

(76) Inventors: Fang Fang, Fremont, CA (US); Steven Hartman, Hermosa Beach, CA (US); Tim Kaiser, Campbell, CA (US); Alex Wu, San Francisco, CA (US); Weiping Peng, San Jose, CA (US)

(21) Appl. No.: 12/619,510

(22) Filed: Nov. 16, 2009

(51) Int. Cl. G06Q 30/00

(52) U.S. Cl. 705/14.49

(57) ABSTRACT

An online audience is targeted for advertisement delivery in an advertising exchange system. The method is performed in an advertising exchange system and may include processing a request to delivery at least one message over a network. An audience segment may be stored for a first entity. The audience segment may identify a population of visitors to one or more network locations of the first entity that form a target-group of members based on activity of the visitors at the first entity. The system may retrieve the audience segment for a second entity and the system may deliver a message from the advertising exchange system in response to the request to the target-group of members on behalf of the second entity by using the audience segment to target the target-group of members.

### BACKGROUND

1. Field

The information disclosed relates to audience sharing in online advertising. More particularly, the information disclosed relates to an advertising exchange system that allows the audience of a market player to be shared as an asset with others in that exchange to increase the amount of advertisement revenue that may be generated from that audience. Importantly, the system may share the audience asset as an asset distinct from an advertising inventory asset (an asset that represents the number of ad spaces available for sale on a website during a certain time frame).

2. Background Information

The marketing of products and services online over the Internet through advertisements is big business. In February 2008, the IAB Internet Advertising Revenue Report conducted by PricewaterhouseCoopers announced that PricewaterhouseCoopers anticipated the Internet advertising revenues for 2007 to exceed US$21 billion. With 2007 revenues increasing 25 percent over the previous 2006 revenue record of nearly US$16.9 billion, Internet advertising presently is experiencing unabated growth.

Unlike print and television advertisement that primarily seeks to reach a target audience, Internet advertising seeks to reach target individuals. The individuals need not be in a particular geographic location and Internet advertisers may elicit responses and receive instant responses from individuals. As a result, Internet advertising is a much more cost effective channel in which to advertise.

Buying and selling ads online requires a variety of market players, including advertisers, publishers, agencies, networks, partners, and developers. To simplify the process of buying and selling ads online, some companies provide mutual organization systems that connect advertisers and publishers in a unified platform that serves as exchange facilities for advertisers, publishers, and other market players to buy and sell ads online. While some of these systems are efficient and effective, it is desirable to provide additional digital advertising solutions that continue to streamline the process of planning, buying, and/or optimizing display advertising.

### SUMMARY

An advertising exchange system targets an online audience for advertisements. The advertising exchange system processes a request to delivery at least one message over a network. An audience segment may be stored for a first entity. The audience segment may identify a population of visitors to one or more network locations of the first entity that form a target-group of members based on activity of the visitors at the first entity. The system may retrieve the audience segment for a second entity, and the system may deliver a message from the advertising exchange system in response to the request to the target-group of members on behalf of the second entity by using the audience segment to target the target-group of members.

### BRIEF DESCRIPTION OF THE FIGURES

FIG. 1 illustrates an advertising exchange system 100.

FIG. 2 is a block diagram illustrating a system 200.

FIG. 3 is block diagram illustrating use case 300.

FIG. 4 is flow diagram illustrating a process 400 to target online audience 220 for advertisement in advertising exchange system 204 based on use case 300.

FIG. 5 is block diagram illustrating use case 500.

FIG. 6 is flow diagram illustrating a process 600 to acquire and resell audience segments 220 in advertising exchange system 204 based on use case 500.

FIG. 7 is block diagram illustrating use case 700.

FIG. 8 is flow diagram illustrating a process 800 to book audience segment 220 on fourth-party website 210 in advertising exchange system 204 based on use case 700.

FIG. 9 is a diagrammatic representation of a network 900.

### DETAILED DESCRIPTION

The following describes the use of an advertising exchange system to sell, buy, or otherwise share an online audience within that exchange. Here, the advertising exchange system may allow others to utilize the audience of a market player as an asset within that exchange to online advertisements. Importantly, the system may allow members to share the audience asset within that exchange as an asset distinct from an advertising inventory asset (an asset that represents the number of ad spaces available for sale on a website during a certain period). In other words, member may trade an audience segment independent of an inventory segment. Monetizing an advertising audience within the online advertising exchange may increase the amount of advertisement revenue that may be generated from that audience and provide that audience with a more enriched online experience.

The below describes examples of the advertising exchange system using a number of terms, some of which may overlap. To aid in clarity, some details of the terms used to describe these example follow. However, these terms define general concepts, and thus are not to be construed narrowly.

The advertising exchange system may be a mutual organization system that connects advertisers and publishers in a unified platform that serves as exchange facilities for advertisers, publishers, and other market players to buy and sell advertisements online. The market players may maintain their own network locations including a website where they may interact with visitors or users to those websites. The system may compile the online identity of these website visitors or users into an advertising audience asset. Members then may trade the advertising audience asset within the advertising exchange system. While the market players within the advertising exchange system may be buyers and sellers of a variety of assets, the examples may identify them as a buyer entity or seller entity when dealing with an advertising audience asset. When trading in an asset that does not include an advertising audience asset, the examples may identify players as other than a buyer entity or seller entity for clarity.

Advertising inventory may be an asset that represents the number of ad spaces available for sale on a network location during a certain time frame. A network location may include a website or other online item that may have a unique name that may identify a network server. A publisher may be a website that has inventory to receive delivery of advertisements, including messages and communication forms used to help sell products and services. A website may have one or more webpages and the publisher's website may display advertisements its webpages. Visitors or users may include those individuals that access webpages through use of a browser. However, the description also may use the term “user” to describe entities that use the advertising exchange system, such as users that access an application on the advertising exchange system to set parameters. The system may refer to various participants of the advertising exchange system as “entities.” Thus, the system generally may use the term entity to describe any number of participants of the advertising exchange system. Those participants include advertisers, publishers, advertising networks, and integrator networks.

An advertising network typically integrates entities, such as advertisers and publishers. An advertising network typically operates in conjunction with advertisers and publishers to deliver ads, from one or more advertisers, to webpages of one or more publishers. For example, Yahoo! Inc®, the assignee of the present invention, operates such an advertising network.

An integrator network entity generally defines a participant of the advertising exchange system that represents or integrates one or more entities on the advertising exchange system (e.g., advertisers, publishers, advertising networks, etc.). For example, an integrator network may represent advertisers on the advertising exchange system to deliver advertisements and other messages to publishers, advertising networks, and other integrator networks. In some examples, the description may refer to integrator networks as the “users” of the advertising exchange system. The integrated networks may comprise third party agents that operate on behalf of or are part of the integrator network. The description generally may use the term “third party agent” to describe an agent or customer that participates in transactions on the advertising exchange system. Similarly, the description may use the term “third party recipient” to describe a user or participant of the advertising exchange system that receives information from the system, such as bid requests. However, the terms integrator networks, third party agents, and third party recipients may be intended to represent a broad class of entities, including publishers, advertisers and networks, as well as the agents that represent them, that operate on the advertising exchange system.

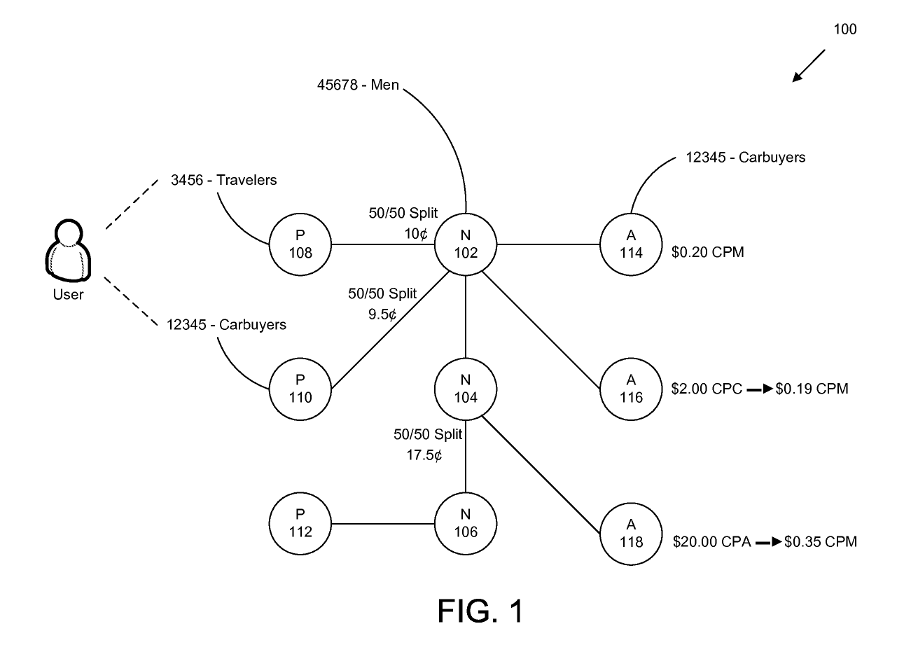

FIG. 1 illustrates an advertising exchange system 100. Advertising exchange system 100 may be a mutual organization system that connects entities in a unified platform. The unified platform may serves as online exchange facilities for advertisers, publishers, and other market players to buy and sell assets related to advertisement.

Advertising exchange system 100 may allow individuals to log into the exchange to become a buyer or seller. The process may be achieved through software programs written to act on behalf of individual people, who themselves may be representing business entities. To aid in clarity, it may help to have a description of workings of advertising exchange system 100.

Advertising exchange system 100 may include several exemplary entities that may participate in advertising exchange system 100. For example, advertising exchange system 100 (exchange system 100 or exchange 100) may include a first network 102, a second network 104, and a third network 106 as integrator network entities. Advertising exchange system 100 may include a first publisher 108, a second publisher 110, and a third publisher 112 as well as a first advertiser 114, a second advertiser 116, and a third advertiser 118. One of ordinary skill recognizes that the entities are exemplary and that exchange 100 may contain other networks, publishers, advertisers, and/or other entities.

Publishers 108, 110, 112 preferably have content that may be of interest to consumers of such content. For example, publisher 108 may have content for travelers, while the publisher 110 has content for car buyers. In particular, publisher 110 may have a webpage such as Edmunds.com (trademark pending) directed to car buyers. Users of the Internet may visit the webpage of publishers 108, 110, 112 to obtain the content provided.

Some examples log the visits and/or activities of the users on the webpage. The system may utilize the log to divide the visitors according to logically related data elements and to generate segments of users who interact with the content. Each segment may consist of logically related data elements in a defined sequence. The segment may be a market segmentation of people or organizations sharing one or more characteristics that cause them to have similar product and/or service needs. As a sub-sector or market niche, the segment may be a grouping that may be more narrowly defined and smaller than a sector. Each segment may be a smaller part of a larger market consisting of customers grouped by characteristic shared by others in their group to allow companies to target or market those customers with advertisements. An organization may focus marketing actions such as advertisement toward geographic, demographic, or other customer classification for the purchase and use of its products and services.

Each segment may include unique identifier that may be unique to the segment, and may be unique to the entity. In this example, advertising exchange system 100 may assign the identifier “3456” to the segment “Travelers” of the publisher 108, assign the identifier “12345” to the segment “Car Buyers” of the publisher 110, and assign the identifier “45678” to the segment “Men” of the network 102.

As users and/or segments of users interact with the content provided by publishers 108, 110, 112, “ad calls” may be generated for the publishers' advertising inventory. Advertising inventory may be ad spaces available for sale on a website during a certain time frame and advertisements may be the supply to fill those ad spaces. Generally, advertisers 114, 116, and 118 may bid to supply advertising to the available inventory. For example, advertiser 114 may bid $0.20 CPM (Cost per Thousand), advertiser 116 may bid $2.00 CPC (Cost per Click), and advertiser 118 may bid $20.00 CPA (Cost per Action). Some systems normalize the bids and/or costs to CPM. Hence, the $2.00 CPC may be normalized to $0.19 CPM, and the $20.00 CPA to $0.35 CPM.

As noted above, an integrator network may represent advertisers on the advertising exchange system to deliver advertisements to publishers, advertising networks and other integrator networks. Integrator networks 102, 104, 106 may have split fee arrangements with the publishers 108, 110, 112. In this example, there is a 50/50 split fee arrangements between each publisher 108, 110, 112, and each network 102, 104, 106. Other fee arrangements, however, are recognized by one of ordinary skill. In operation, advertiser 114 would pay $0.20 CPM to network 102 and network 102 would share or split half of that with publisher 108 based on their 50/50 split fee arrangement.

Advertisers 114, 116, 118 typically have advertising campaigns that include one or more ad creatives. Each ad creative may be a complete ad to be run, including text, graphics, and layout, where that ad creative promotes a particular brand or product. Advertisers 114, 116, 118 may wish to specify certain criteria for each campaign such as, for example, maximum spend per day on the delivery of advertising, and/or criteria for targeted advertising. Examples of “hard targeting” include directing an advertisement to a particular gender and/or during a particular time of day. Advertisers 114, 116, 118 may further target particular users and/or segments of users. Particular transactions and/or data may have additional value for advertising exchange system 100. For instance, one or more ads and/or campaigns for advertiser 114 may have particular relevance to the Car buyers 12345.

In one implementation, an ad server maintains a history of attributes for several advertisements, and predicts the value per advertisement in relation to each publisher. The ad server may perform the foregoing alternatively, or in conjunction with, behavioral type targeting based on user data. In some of these examples, each user has a cookie space that may be used by various entities to store information. For instance, one or more entities within advertising exchange system 100 advantageously may write into a user's cookie space an integer identifier that corresponds to a particular user segment.

A user cookie space may include stored segment identifiers such as, for example, 12345—CarBuyers, 3456—Travelers, and 45678—Men, that advantageously may be used to target and/or generate the users and/or segment(s). A separate user cookie space may store different segment identifiers based on a different user's interests and/or activities. Alternatively, information such as user segment data may be stored in a back end data storage or user data storage that may be coupled to a server. Here, user segment information may be stored in and utilized from a user data storage rather than from a local user cookies, since local user cookies may be less accurate.

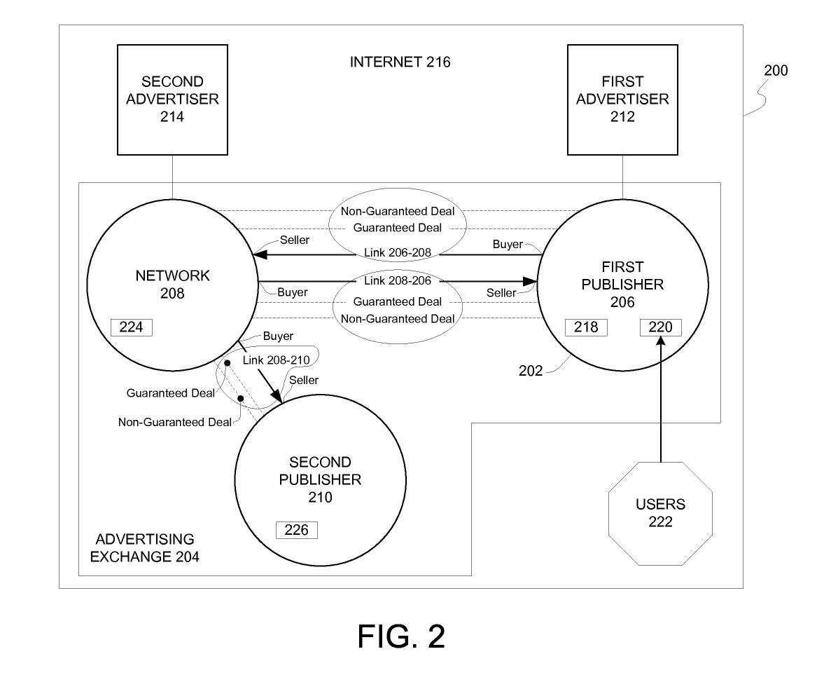

FIG. 2 is a block diagram illustrating a system 200. System 200 may be a group of independent but interrelated elements that may give advertising market players 202 an ability to buy, sell, or otherwise trade a list of users who have been segmented into a custom business target audience. As a participating member 202 in an advertising exchange system 204, the audience segment originator may sell their audience segment through electronically linked, third-party sales channels to increase their profitability. By allowing the audience represented in that audience segment to be made available to third-party demand channels, the volume and liquidity of demand on exchange 204 will be increased.

Market players 202 may be individuals, corporations, and other entities that are member of exchange 204. Exchange members may participate in the online advertisement business such as by operating a disparate website. A website may be a collection of related webpages, images, videos or other digital assets that are addressed with a common domain name or IP address in an Internet Protocol-based network.

Exchange 204 may be a mutual organization system that connects advertisers and publishers in a unified platform that serves as exchange facilities for advertisers, publishers, and other market players to buy and sell ads online. Exchange 204 may enable relationships by creating an effective auction marketplace to provide agencies, advertisers, publishers, and networks a direct line to buy and sell on their own. Exchange 204 may separate itself from the fragmented online media world by providing a single online destination that gives publishers, advertisers, ad networks, and agencies a simple, scalable way to reach targeted audiences with effective monetization of assets and other resources.

An example of exchange 204 is the advertising platform “APT from Yahoo!”® operated by internet service provider Yahoo!® Inc. of Sunnyvale, Calif. “APT from Yahoo!”® includes software for advertising services such as managing online advertising and marketing. “APT from Yahoo!”® allows on-line advertising via computer networks and provides a website for the management of online advertising campaigns for others, including providing advertising information to target customers, and disseminate advertising for others via the Internet computer. Here, “APT from Yahoo!”® may help simplify the process of buying and selling ads and inventory online for advertisers, publishers, ad networks, and agencies of all sizes through programmatic access to buy and sell publishers' inventory and advertisers' ads on the APT exchange. APT leverages the systems of the largest internet publisher, Yahoo!®, and the first and largest exchange marketplace, the Right Media Exchange to unify the market by connecting all players on a single platform.

Transactions on advertising exchange system 204 may be between (i) buyers and sellers, (ii) intermediaries (e.g., brokers, which may be a buyer or seller), or (iii) buyers or sellers and intermediaries. In general, market players 202 may include sellers and buyers. A seller may be an entity that contracts to acquire some form of consideration in return for an asset. A buyer may be an entity that contracts to acquire an asset in return for some form of consideration.

In this discussion, those identified as a seller or a buyer may be entities that deal in selling and buying an audience within advertising exchange system 204 as an integrated market place that allows a seller to sell an audience independent of inventory segments and allows a buyer to buy that audience independent of inventory segments. Entities within advertising exchange system 204 additionally deal in other assets. To provide clarity, when an entity is dealing in selling and buying an audience, the description generally may identify the entity as a buyer or seller. When dealing in selling and buying an asset other than an audience or when dealing in a function other than buying or selling, the description generally may identify the entity as something other than a buyer or seller, such as a customer or merchant.

Market players 202 may include a first publisher 206 in communication with a network 208 and a second publisher 210 in communication with network 208. Market players 202 additionally may include advertisers, agencies, partners, developers, and users as well as other publishers and networks. From outside exchange 204, a first advertiser 212 may be in communication with first publisher 206 and a second advertiser 214 may be in communication with network 208. Each entity may be part of and communicate through Internet 216.

Advertising inventory or ‘inventory’ may be the number of ad spaces available for sale on a website during a certain time frame. In other words, inventory may be the collection of ad space that publishers offer for sale over a specified period of time. A websites inventory may be determined by taking into consideration the number of advertisements on a page, the number of pages with advertisements, and the number of page views during a specific time frame.

First publisher 206 may be a self-managed publisher in that first publisher 206 may supply inventory 218 on exchange 204 directly as an exchange member 202. This may allow publishers to leverage ads from the breadth of advertisers available in exchange 204. First publisher 206 additionally may include an audience segment 220. In the context of audience segment 220, first publisher 206 may be thought of as a first publisher seller 206 since first publisher seller 206 ultimately may want to share audience segment 220 with other exchange members 202 to increase the advertising revenue that may be acquired though audience segment 220.

Audience segment 220 may be a list of users who have been segmented from users 222 into a custom business target audience by first publisher seller 206. Users 222 may be individuals who have accessed one or more webpages maintained by first publisher 206, where first publisher seller 206 also may participate as an exchange member 202. As discussed through example in more detail below, first publisher 206 may be the health information services website operated by WebMD® and segment 220 may be an arthritis audience segment compiled into a list of all users 222 that meet a predefined selection criteria, such as having read an arthritis article hosted by first publisher 206 at least once in the last five days.

Network 208 may be a company that manages other publishers, advertisers, and/or agencies, which may include any third-party agency that, under an agency contract, participates in exchange 204 on behalf of the agency clients. Network 208 may host the software that operates exchange 204 and can set up business relationship with other members on exchange 204. Network 208 may conduct transactions in exchange 204 on behalf of the publishers, advertisers, and agencies it manages. Network 208 may supply inventory 224 on exchange 204. Further, network 208 may manage multiple properties such as mail, finance, auto, and news. In one example, network 208 may be an integrator network entity. In another example, network 208 may be internet service provider Yahoo!® Inc. of Sunnyvale, Calif. When acquiring audience segment 220 from first publisher seller 206, network 208 may be view as network buyer 208.

Second publisher 210 may be a self-managed publisher in that second publisher 210 may supply inventory 226 on exchange 204. Subsequent process may result in link agreements between network 208 and first publisher 206 and/or network 208 and second publisher 210, where the link may include at least one guaranteed online advertising contract and nonguaranteed online advertising contracts. Members of exchange 204, which is first publisher 206, network 208, and second publisher 210, then may vie for inventory 218, 224, and 226 through a bidding process.

The next discussion generally deals with transacting impression opportunities in exchange 204 and some details may provide some clarity. An impression opportunity may be an advertising position on a webpage ready to receive an advertisement. A company may take advantage of that opportunity by delivering an advertisement or other message to that impression opportunity to generate an impression. The message may be any electronic communication. A single appearance of advertisement on a webpage may be considered an advertisement impression. Some companies may transact as many as twenty billion advertisement impressions per day.

Guaranteed online advertising contracts require the impression seller to provide a certain amount of impressions to the buyer over a fixed period for a fixed price. Nonguaranteed online advertising contracts may require the impression seller to provide an impression only if one is available at impression buyer's set price and buyer agrees to pay for the impression only after seller delivers it. In FIG. 2, the direction of the link arrow shows the direction of revenue from the inventory customer to the inventory merchant. For example, link 208-206 has network 208 sending revenue to first publisher 206 in exchange for gaining access to impressions 218. Link 208-206 may include one or both of a guaranteed contract deal or a nonguaranteed contract deal. While many exchange member 202 may share in the advertisement revenue, the revenue initially comes from an advertiser.

First advertiser 212 may be a managed advertiser in that first advertiser 212 may list advertisements on exchange 204 indirectly as a customer of a network that participates as an exchange member 202. By allowing first publisher 206 to manage the advertising account of first advertiser 212, first advertiser 212 may leverage inventory provided by a range of publishers within exchange 204. Second advertiser 214 may be a managed advertiser that gains indirect access to exchange 204 through network 208.

Internet 216 may be a computer network that includes a worldwide network of computer networks that use common network protocols to facilitate data transmission. As a global system of interconnected computer networks, Internet 216 may be a largest internet in the world. Internet 216 may permit users to communicate and share information.

System 200 may involve audience sharing, reselling, revenue sharing, which may utilize rate values and prices. Audience sharing may include an ability to target any audience on any inventory given an agreement by financial stakeholders of the transaction. Reselling may be an audience owner allowing the buyer of its audience segment to sell it to a third-party network.

Revenue sharing may include distribution of revenue collected from an advertiser across the parties deserving revenue. Revenue sharing may be viewed as a cost per sale paid by an exchange member 202 to affiliates as a certain percentage of sales revenues generated by customers whom the affiliate refer via various advertising methods. In another example, people working together and registering online in a way similar to that of a corporation may share in proceeds through revenue sharing.

Revenue shares may be contained in a deal and may be expressed as a percentage (%), Cost per thousand (CPM), cost per click (CPC), cost per action (CPA), flat rate, or a combination thereof. A rate card may be a document containing prices and descriptions for various ad placement options available from a media outlet. Rates listed in a rate card may include a floor value, a list value, and a target value at which a seller values their audience. Price may be the amount charged to a buyer through an order as calculated based upon input from rates, revenue shares, discounts or any other services/adjustments.

An example explanation of system 200 may be presented in use case models. A use-case model may include actors, use cases, and relations among them. Actors may represent items that exchange information with the system, including what are typically called users. When an actor uses the system, the system may perform a use case.

The following describes several use cases, including use case 300, use case 500, and use case 700. Use case 300 may demonstrate an ability for segment originator 206 to target inventory 224 on third-party website 208. Use case 500 may demonstrate an ability for network 208 to resell segments 220 as reseller 208 to a new third party, here second advertiser 214. Use case 700 may demonstrate an ability for network 208 to book the audience of first publisher 206 on fourth-party website 210. Typical steps involved in each use case include deal making, rate setting, demand creation, serving, and reporting.

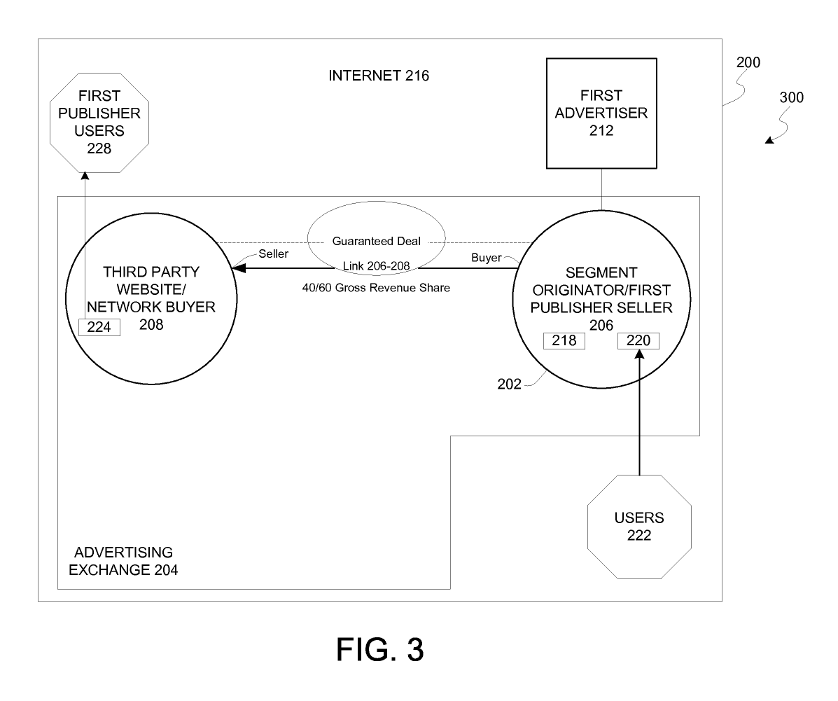

FIG. 3 is block diagram illustrating use case 300. Use case 300 may demonstrate an ability for a seller, here segment originator 206, to target inventory 224 on third-party website 208. In this example, first advertiser 212 may be represented by McNeil Consumer Healthcare and first publisher 206 may be represented by health information services provider WebMD®. First publisher 206 and first advertiser 212 may have agreed to have 1,000,000 impressions of an advertisement for the pain relieving drug Tylenol® posted over thirty days for US$14,500 (floor price of $14.50 CPM). WebMD® may benefit by earning and receiving the US$14,500 in advance of actually supplying the impressions and McNeil Consumer Healthcare may benefit from knowing that their advertisement will be displayed a guaranteed number of times for a capped cost during a time preselected by McNeil Consumer Healthcare.

In advance of the Tylenol® advertisement agreement, first publisher 206 has prequalified at least 1,000,000 of its webpage to be listed in segment 220 as having an interest in arthritis issues. In one example, first publisher 206 WebMD® compiled arthritis audience segment 220 to include all users 222 that have accessed an arthritis article at least once in the last five days from the WebMD® webpages.

In general, custom business target segment 220 may be built by interspaced activity of users 222 on online property maintained by first publisher 206. Audience segment 220 may be a market segmentation of people or organizations sharing one or more characteristics that cause them to have similar product and/or service needs. The population of visitors 222 to the webpages maintained by first publisher 206 may include the entire aggregation of individuals accessing the webpages from which samples can be drawn. Audience segment generator 206 may obtain audience segment 220 by dividing the population of visitors 222 to the webpages maintained by first publisher 206 into a target-group based on the activity of those visitors 222 in the webpages. Segments may be delivered to those first publisher users 228 that qualify on first publisher 206 when first publisher user 228 shows up on property managed by network 208. To increase the relevance the Tylenol® advertisement has to each user that views the Tylenol® advertisement, first publisher 206 may desire to target arthritis audience segment 220.

In the example, first publisher 206 realizes that it can only service 500,000 impressions over the next thirty days through impressions 218 and desires to obtain the remaining 500,000 impressions from impressions 224 owned by network 208. In other words, first publisher 206 anticipates only 500,000 impressions opportunities in its webpages from the population listed in segment 220 but anticipates 500,000 additional impressions opportunities in the webpages maintained by network 208. That is to say, 500,000 impressions on the webpages maintained by network 208 likely may be viewed by WebMD®'s audience listed in segment 220. Here, first publisher 206 may desire to enter into a guaranteed online advertising contract with network to make 500,000 impressions of the Tylenol® advertisement to only those users listed in arthritis audience segment 220. Network 208 is considered a third party to the McNeil 212-WebMD® 206 advertising contract and may be referred to as third party website 208 in this example.

Use case 300 may involve several business context/assumptions/preconditions. For example, in addition to first publisher 206 holding a seat on exchange 204 as a self-managed publisher, network 208 holding a seat on exchange 204 as a network that manages multiple properties, and first advertiser 212 being a first publisher 206 managed advertiser, first publisher 206 may desire to buy inventory 224 targeting custom business target segments 220 of first publisher 206. In addition, first publisher 206 has an existing custom business target (Custom BT) segment/ready business segment (RBS) 220 that would find the advertisements relevant. Moreover, network 208 maintains active rate cards, first advertiser 212 has an interest in targeting custom business target segments 220 on properties of network 208, and web surfers 228 are already qualified for segment 220, here the arthritis segment.

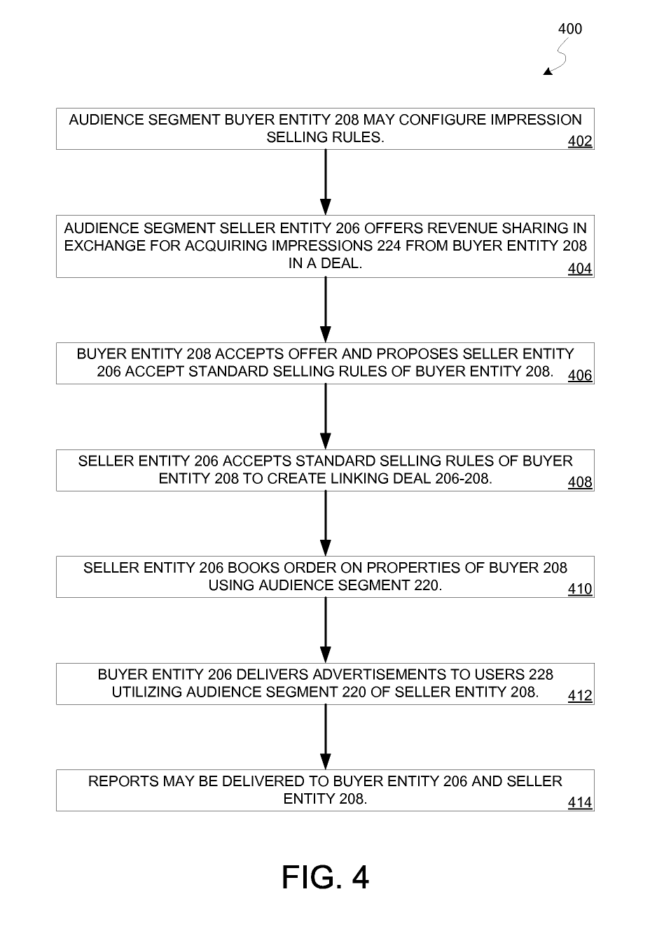

FIG. 4 is flow diagram illustrating a process 400 to target online audience 220 for advertisement in advertising exchange system 204 based on use case 300. Online audience 220 may be a group of consumers, each of whom may be connected to a computer network and may be a member of a predefined segment. Here, system 200 may employ the following steps to allow first advertiser 212 to target inventory 224 on third-party website 208 through its relationship with segment originator 206. At step 402, the yield manager for network 208 first may configure her standard impression selling rules to opt-in to all content topics, all ad sizes, and all sites. Targeting control may allow any behavioral targeting without any booking limits. The impression selling rules additionally may be set to utilize a standard rate tag. In this example, the rate card may specify a $4.00 CPM base rate, a 10% gender demographics mark-up, a 10% age demographics mark-up, and a 25% mark-up for targeting segments (first publisher 206 arthritis markup).

With the impression seller's standard selling rules set, the method may create a linking deal between first publisher seller 206 and network buyer 208. The business development manager for first publisher seller 206 may send a request to network buyer 208 to establish a linked relationship with first publisher 206 where first publisher 206 is the impression buyer and network 208 is the impression seller. However, first publisher 206 may be referred to as first publisher seller 206 since first publisher seller 206 ultimately will be selling audience segment 220 to network buyer 208 in this example.

At step 404, the business development manager for first publisher seller 206 may propose a guaranteed deal in the impression offer where first publisher seller 206 will be able to target their arthritis segment 220 on inventory 224 of network 208. Instead of utilizing the rate card, the business development manager for first publisher seller 206 proposes paying network 208 40% of the gross revenue in a 40/60 gross revenue share arrangement.

The offer received by network 208 from first publisher 206 may be routed to the business development manager for network 208. The business development manager for network 208 reviews the link offer proposal and, in this example at step 406, accepts the offer and proposes that the impression buyer accept standard selling rules of network 208. The impression buyer, here audience segment seller 206 represented by its business development manager views the acceptance and additional controls. The business development manager for first publisher 206 accepts at step 408. With the linking deal 206-208 relationship established, the yield manager for network 208 receives notification of the established link 206-208 relationship and determines the rate adjustment that network 208 may use for the arthritis segment 220 (25%) in the rate cards.

The sales representative for first publisher 206 then may book a run of network (RON) order on the properties owned and operated (O&O) by network 208 using audience segment 220 from first publisher 206 at step 410. For example, the sales rep may book one ad grouping targeting RON on O&O guaranteed delivery (GD), with Custom BT segment arthritis, Males, 30-50. In this example, the sales rep is able to reserve inventory against this booking since the rate presented to him takes into account the 25% mark-up and 40% revenue share agreement.

User 228 surfs the finance pages of network 208 and receives a Tylenol® guaranteed target advertisement. Later, the same user 228 surfs the news pages of network 208 and receives a Tylenol® guaranteed target advertisement at step 412. The advertisement deliveries continue over the next thirty days until 500,000 Tylenol® advertisement impressions are made.

Reporting may be made post condition at step 414. First publisher may view a targeting segment report that details performance, revenue, and reach for guaranteed delivery and non-guaranteed delivery. Network 208 may view a targeting segment report that details performance, revenue, and reach for guaranteed delivery and non-guaranteed delivery. Last, first advertiser 212 may view campaign performance reports.

In sum of use case 300, first publisher 206 requested a buy link with network 208. Network 208 set permissions such as to opt-in all ad sizes, all sites, and all content topics. First publisher 206 allowed its own network to target the audience defined by arthritis segment 220 on network 208's inventory. In sharing the $14,500 revenue collected from first advertiser 212, network 208 received 40% of $14,500 (namely, $5,800) and first publisher 206 received the reminder as gross profits, here $8,700. The rate card for network 208 contained a mark-up of 25% for WebMD® segment arthritis and first publisher 206 booked an order for the Tylenol® advertisements with the following targeting in a guaranteed deal placement: network 208, RBS: arthritis, Demo: Males, 30-50.

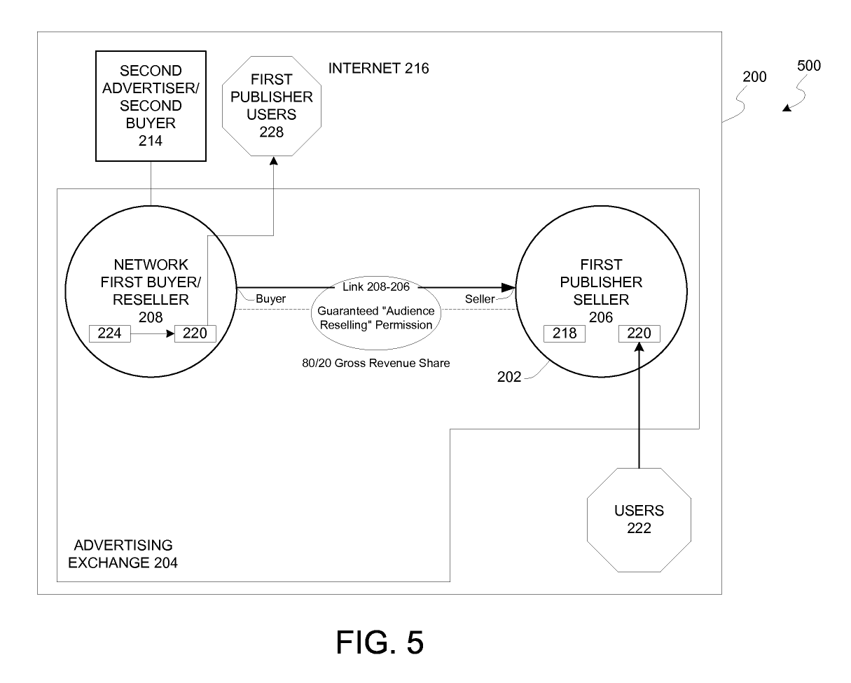

FIG. 5 is block diagram illustrating use case 500. Use case 500 may demonstrate an ability for network 208 to acquire segments 220 as buyer 208 and then resell segments 220 as reseller 208 to a new third party, here second advertiser 214. In this example, second advertiser 214 may be represented by German chemical and pharmaceutical company Bayer® AG, well-known for its original brand of aspirin. Second advertiser 214 and network 208 may have agreed to have 1,000,000 impressions of an advertisement for the pain relieving drug Bayer® brand aspirin posted over thirty days for US$5,800 (floor price of $5.80 CPM). In use case 500, network 208 and first publisher 206 secured a contract similar to that in use case 300, but additionally agreed to audience reselling in which network 208 may resell arthritis segment 220 to Bayer® AG on inventory 224 of network 208 or other third party inventory (such as inventory 226 FIG. 2).

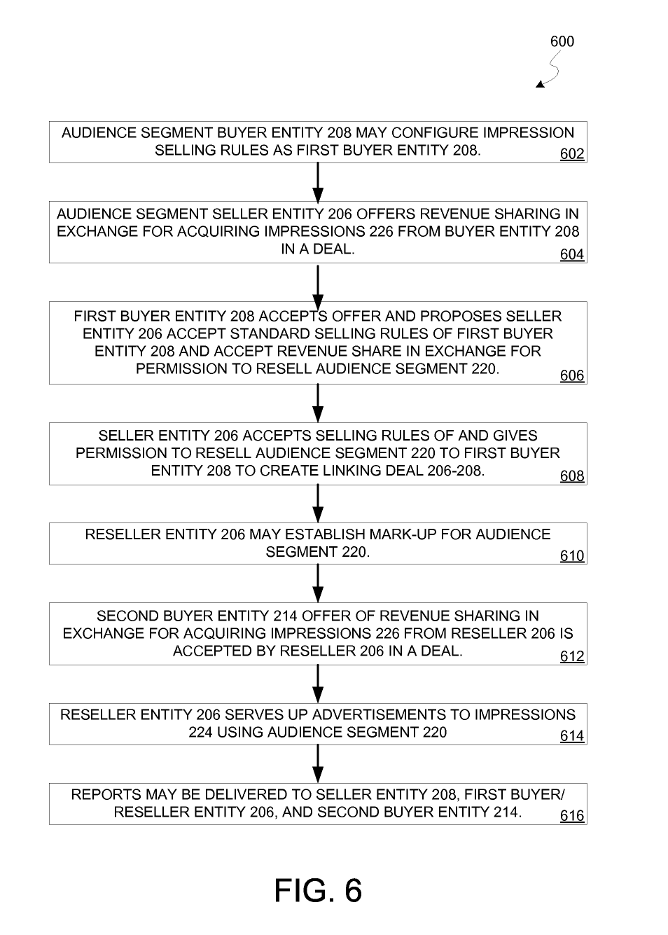

FIG. 6 is flow diagram illustrating a process 600 to acquire and resell audience segments 220 in advertising exchange system 204 based on use case 500. Step 602 and step 604 may be similar to step 402 and step 404, respectively, in process 400. Step 606 may be similar to step 406 in process 400 with the additional dealing making step of buyer 208 buying “audience reselling” permission and seller 206 selling audience reselling permission. Here, network buyer 208 and first publisher 206 secure a guaranteed deal with “audience reselling” permission, where network buyer 208 is the buyer of audience segment 220 and first publisher seller 206 is the seller of audience segment 220. Thus, at step 608, first publisher seller 206 has specified that they will allow network buyer 208 to resell arthritis segment 220 on inventory 224 of network 208 or other third party inventory. In revenue sharing, network buyer 208 agrees to pay first publisher seller 206 20% of the gross revenue that network buyer 206 collects as network seller 206 for reselling segment 220 on network 208 inventory 224 or other third party inventory.

At step 610, network reseller 208 may engage in the rate setting step by setting a 25% mark-up for the arthritis segment 220. This may result in setting a floor at $5.80 CPM. At step 612, network reseller 208 may engage in the demand creation step by contracting with second advertiser buyer 214, who desires to run a campaign using arthritis segment 220 for RON of network 208. After quoting a floor price of $5.80 CPM, network 208 books the order.

At step 614, network reseller 208 may serve up the advertisements in the serving step, each first publisher user 228 who visits webpages of network 208 is considered for serving the Bayer® brand aspirin advertisement since each was scored with “arthritis” while visiting webpages of first publisher 206. At step 616, the parties may receive reports. In reporting step 616, network buyer/reseller 208 may see what they need to bill second advertiser buyer 214 and what to pay first publisher seller 206. First publisher seller 206 may see what they need to bill network buyer/reseller 208.

In sum of use case 500, network 208 requests a buy link with first publisher 206. In the resulting network 208-first publisher 206 guaranteed deliver audience reselling deal, first publisher 206 permission allows network 208 to resell arthritis segment 206 in exchange for receipt of a 20% gross revenue sharing arrangement, leaving network 208 with an 80% share of the gross revenue. The rate card for network 208 may include a markup of 25% for arthritis segment 220 on network 208's webpages. In addition to a RON base rate of $4.00 CPM and a demo gender markup of 10%, the rate card may specify a demo age mark up of 10% and a 25% mark up for arthritis segment 220. In sharing the $5,800 revenue collected from second advertiser 214, network 208 received 80% of $5,800 (namely, $4,640 and first publisher 206 received the reminder as gross profits, here $1,160. Here, network 208 booked an order for the Bayer® brand aspirin advertisements with the following targeting in a guaranteed deal placement: network 208, RBS: arthritis, Demo: Males, 30-50.

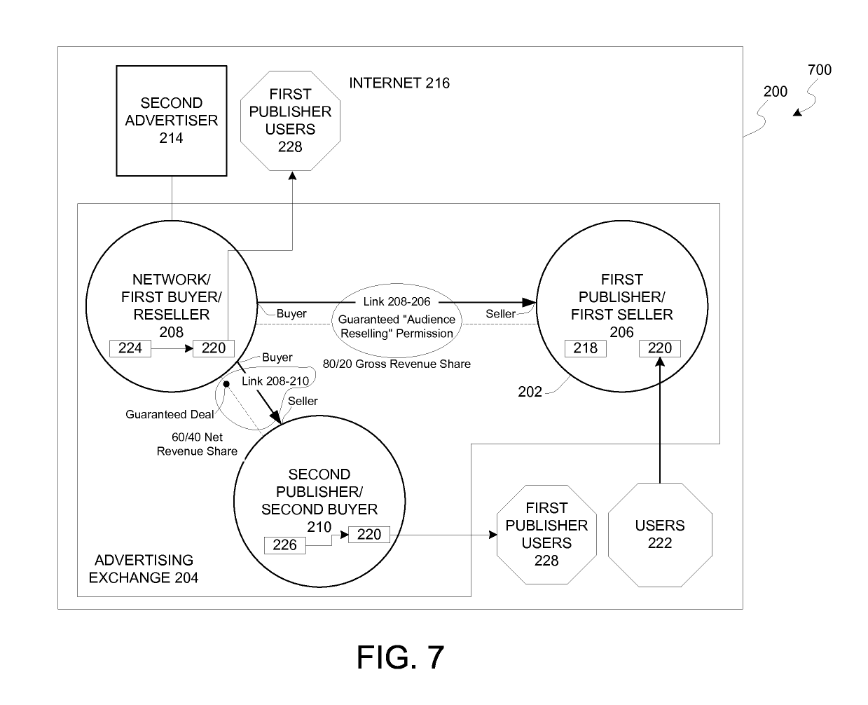

FIG. 7 is block diagram illustrating use case 700. Use case 700 may demonstrate an ability for network 208 to book the audience of first publisher 206 on fourth-party website 210. This may be beneficial to network 208 where network 208 is supply constrained on exercise content which second advertiser 214 is looking to target along with arthritic users.

In this example, second advertiser 214 may continue to be represented by German chemical and pharmaceutical company Bayer® AG and first publisher may continue to be represented by WebMD®. Second publisher 210 may be represented by the webpages owned and operated by Men's Journal®, an American men's lifestyle magazine focused on outdoor recreation. Second advertiser 214 and network 208 may have agreed to have 1,000,000 impressions of an advertisement for the pain relieving drug Bayer® brand aspirin posted over thirty days for US$18,130 (floor price of $18.30 CPM). In use case 700, network 208 and first publisher 206 secured a contract similar to that in use case 500, which included audience reselling that allows network 208 to resell arthritis segment 220 to Bayer® AG on inventory 224 of network 208 or other third party inventory, such as inventory 226 of second publisher 210.

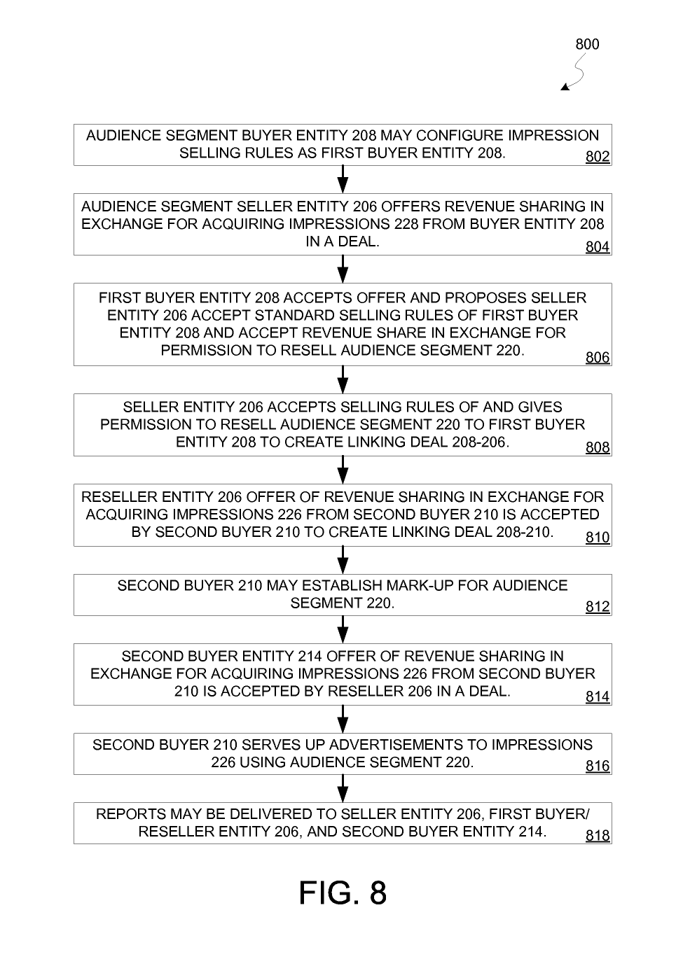

FIG. 8 is flow diagram illustrating a process 800 to book audience segment 220 on fourth-party website 210 in advertising exchange system 204 based on use case 700. Step 802 to step 808 are similar to step 602 to step 608, respectively, in process 600 of FIG. 6. For example, in the dealing making step 808, network buyer 208 and first publisher seller 206 secure a guaranteed deal with “audience reselling” permission, where network 208 is the buyer of the audience reselling permission and first publisher 206 is the seller of the audience reselling permission. Here, first publisher seller 206 has specified that they will allow network buyer 206 to resell arthritis segment 220 on inventory 224 of network 208 or other third party inventory. In revenue sharing, network first buyer/reseller 208 agrees to pay first publisher 206 20% of the gross revenue that network 206 collects for reselling segment 220 on network 208 inventory 224 or other third party inventory.

At step 810, network 208 and second publisher 210 enter into a guaranteed deal with network 208 as the inventory buyer and second publisher 210 as the inventory seller. In the network 208-second publisher 210 agreement, network 208 has specified that they desire to target on inventory 226 of second publisher 210 an audience composed of former web surfers of first publisher 206 who qualified to be listed in the arthritis segment 220 of first publisher 206. This may be thought of as buyer side targeting control. In revenue sharing, network 208 agrees to pay second publisher 40% of the gross revenue that network 206 collects for reselling segment 220 on network 208 inventory 224 and fourth party inventory 226.

In the rate setting step 812, second publisher 210 has priced their RON rate at $4.00 CPM and a 25% mark-up for arthritis segment 220, and various mark-ups. In the demand creation step 814, network 208 has contracted with second advertiser 214, who desires to run a campaign using arthritis segment 220 in the Men's Journal® site (second publisher 210) for one million impressions. A floor price of $18.13 CPM is quoted. This is based upon the rate card of second publisher 210, associated revenue sharing, and the 20% revenue sharing to which first publisher 206 is to receive. Network 208 then books the order.

In the serving step 816, each first publisher user 228 who visits webpages of second publisher 210 is considered for serving the Bayer® brand aspirin advertisement since each was scored with “arthritis” while visiting webpages of first publisher 206. In the reporting step 818, network first buyer/reseller 208 may see what they need to bill second advertiser second buyer 214 and what to pay first publisher first seller 206 and second publisher 210. First publisher 206 and second publisher 210 each may see what they need to bill buyer/reseller network 208.

In sum of use case 700, network 208 requests a buy link with first publisher 206. In the resulting network 208-first publisher 206 guaranteed deliver audience reselling deal, first publisher 206 permission allows network 208 to resell arthritis segment 220 in exchange for receipt of a 20% gross revenue sharing arrangement, leaving network 208 with an 80% share of the gross revenue. Network 208 also requests a buy link with second publisher 210. In the resulting network 208-second publisher 210 guaranteed deal, network 208 is allowed targeting of arthritis segment 220, which now is white-labeled for network 208. Network 208 agrees to pay second publisher 210 40% of the gross revenue collected.

The rate card for second publisher 210 may include a markup of 25% for arthritis segment 220 on site “mensjournal.com”®. In addition to a RON base rate of $4.00 CPM and a demo gender markup of 10%, the rate card of second publisher 210 may specify a demo age mark up of 10%. In sharing the $18,130 revenue collected from second advertiser 214, network 208 received 40% of $18,130 (namely, $7,252), first publisher 206 received 20% (or $3,626), and second publisher 210 reminder as gross profits, here $7,252. Here, network 208 booked an order for the Bayer® brand aspirin advertisements with the following targeting in a guaranteed deal placement: network: Men's Journal®, RBS: arthritis, Demo: Males, 30-50. In an alternate net fee sharing arrangement, first publisher 206 may receive 20% (or $3,626), leaving $14,504 to be divided 40% to second publisher 210 (namely $5,801.60) and remainder to network 208 (namely $8,702.40).

Cross-Product Convergence Requirements: Audience sharing may be applicable to both guaranteed and non-guaranteed business (principles stated should not be connection tactic-specific). Audience sharing only applies to use cases where an audience segment 220 is being targeted on third-party supply relative to the originator of segment 220. Use cases where segment 220 is being targeted on the originator of the segment 220 may follow existing re-selling principles. If a third-party sales channel has authority to resell a segment on third party inventory, but does not have a direct deal with that segment originator to target their inventory, then that supply cannot be targeted.

A self-managed entity such as first publisher 206 and second publisher 210 must have explicit permission from the operator of exchange 204 to buy/sell segments 220 on third-party inventory. More specifically, this means the ability to create an audience segment and allow a buyer to target that segment on third-party inventory. These are advanced use cases such as network 208 buying second publisher 210 inventory 226 using a first publisher 206 segment 220. If a seller designates that their audience can be resold, then they are allowing that segment to be re-sold across as many links as the platform may support. Universal filters and conditional filters should be able to protect the owner of the audience from being served ads on inventory that they choose may be unfit.

The network being targeted may set a rate (not revenue share or price) for an audience. Consider the situation where the network being targeted in the order does not own the segment. Should that network be able to set rates for that segment when they are not the owners of these segments and have added no value in its creation? On first thought, it would seem that the network should not benefit from the revenue that this segment brings. However, the seller has a right to set a rate for their inventory based upon whatever targeting is being asked by the buyer. Experiments have shown that this will protect the inventory seller from having their inventory cherry picked by preventing others form picking out profitable customers from their large database. In business terms, the cherry picked phrase means to select only what one considers the best, most desirable, profitable product from a number of options. It used with reference to a party taking inappropriate means to gain their objective. Therefore, if a inventory buyer says to the seller “I'd like to buy inventory of yours that meets “X”, “Y”, and “Z” (“Z” being audience) criteria, but you can only charge me for “X” and Y”, then the buyer has cherry-picked. If, however, the buyer says “I'd like to buy “X”, “Y” and “Z”, and I can be charged for targeting “Z”, then that buy has not cherry picked.

Putting the above into context of audience sharing, there emerge two different types of scenarios. The first describes a use case where the seller should be able to rate the buyer's segment and the second use case the seller should not.

Seller Prices Segment: In this scenario, an entity such as first publisher 206 may wish to buy one million sports impressions from network 208, but only when the user may be tagged with arthritis segment 220 from first publisher 206. Here, network 208 may charge first publisher 206 whatever rate they have set for run-of Sports and BT targeting (or first publisher 206 “arthritis” targeting).

Seller Does Not Price Segment: In this arbitrage use case, first publisher 206 desires to buy one million sports impressions from network 208. From that million, first publisher 206 will re-sell that inventory to its advertisers. Here, network 208 may charge first publisher 206 whatever rate they have set for run-of Sports. First publisher 206 may charge their advertisers/buyers whatever they choose, since it now is their inventory. First publisher 206 also may add additional targeting to that supply (like their arthritis segment 220). The inventory provider sets the rate on the audience segment. If one network resells other's inventory, this network cannot set a rate card on that audience segment. The actions by first publisher 206 towards inventory 224 may be now irrelevant to network 208 since inventory 224 now may be considered inventory of first publisher 206. To ensure that the owner of a segment being “shared” receives the revenue they are expecting, revenue sharing needs to be capable of expressing the segment owner's yield expectations.

A buyer and a seller should be able to negotiate revenue sharing based upon either gross or net revenue collected. How should sharing revenue be similar or different between data and media providers? For nonguaranteed deals (NGD), data providers may receive revenue based upon the gross amount collected by the buyer and the media providers may receive revenue from the net amount (reduced revenue) after the data providers have been paid. For example, in use case 700 (FIG. 7), a settlement may take place where network 208 bills second advertiser 214 $600. First publisher 206 bills network 208 $200 (due to the $2.00 eCPM revenue share and second publisher 210 bills network 208 $200 (as they would get 50% of $400 as that may be the revenue after taking into account the data provider cost). This may be because in NGD, the media provider (owner of inventory) has no insight to the value of the behavioral targeting on their supply. In addition, because a publisher's remnant inventory may be auctioned off, the media provider may be assured of receiving the highest bid for each impression.

“However, in guaranteed deals (GD), the value of the behavioral targeting can be assessed by the media provider, since they have the ability to set rates for audience targeting on their supply. In these instances, it may be possible that media providers would demand that they receive revenue share based upon the gross amount collected and not off the net due to data provider reductions. Nonetheless, during the revenue sharing negotiation of a deal, the buyer and the seller should be able to specify whether sharing may be based off gross or net revenue collected.

Deal interactions should be consistent between a seller and a buyer. In other words, if one party makes a change to the information visible on a deal, then it should be viewed as a proposal for updating the deal (thus, the current deal details are to remain intact until both parties agree on the update).

Storing may involve putting or retaining data in a memory unit such as a storage medium. Retrieving may involve locating and reading data from storage. Delivering may involve carrying and turning over to the intended recipient. Audience segment 220 may be stored by retaining data representing audience segment 220 in a memory unit, for example. Audience segment 220 then may be retrieved and delivered downstream for processing. A message such as an advertisement may be retrieved from the advertising exchange system, carried over a network, and turned over to a member of a target-group of members.

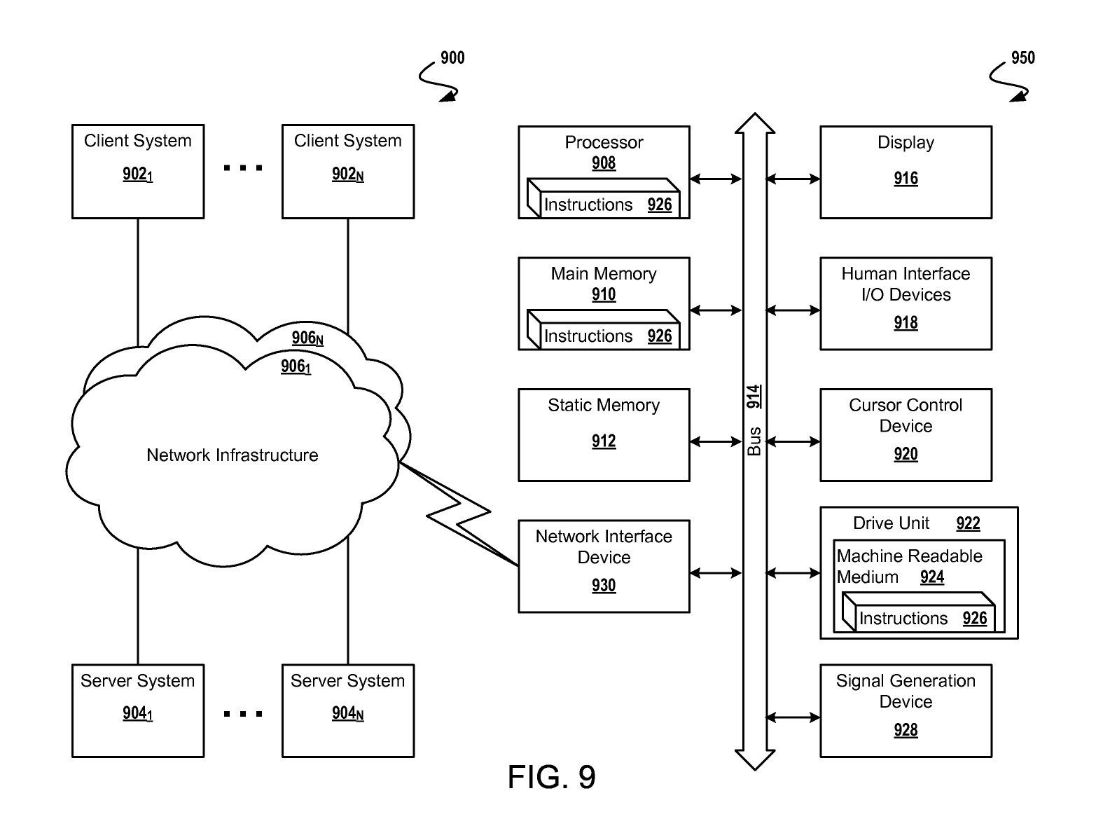

FIG. 9 is a diagrammatic representation of a network 900, including nodes for client computer systems 902₁ through 902_{N}, nodes for server computer systems 904₁ through 904_{N}, nodes for network infrastructure 906₁ through 906_{N}, any of which nodes may comprise a machine 950 within which a set of instructions for causing the machine to perform any one of the techniques discussed above may be executed. The embodiment shown is purely exemplary, and might be implemented in the context of one or more of the figures herein.

Any node of the network 900 may comprise a general-purpose processor, a digital signal processor (DSP), an application specific integrated circuit (ASIC), a field programmable gate array (FPGA) or other programmable logic device, discrete gate or transistor logic, discrete hardware components, or any combination thereof capable to perform the functions described herein. A general-purpose processor may be a microprocessor, but in the alternative, the processor may be any conventional processor, controller, microcontroller, or state machine. A system also may implement a processor as a combination of computing devices (e.g., a combination of a DSP and a microprocessor, a plurality of microprocessors, one or more microprocessors in conjunction with a DSP core, or any other such configuration, etc).

In alternative embodiments, a node may comprise a machine in the form of a virtual machine (VM), a virtual server, a virtual client, a virtual desktop, a virtual volume, a network router, a network switch, a network bridge, a personal digital assistant (PDA), a cellular telephone, a web appliance, or any machine capable of executing a sequence of instructions that specify actions to be taken by that machine. Any node of the network may communicate cooperatively with another node on the network. In some embodiments, any node of the network may communicate cooperatively with every other node of the network. Further, any node or group of nodes on the network may comprise one or more computer systems (e.g., a client computer system, a server computer system) and/or may comprise one or more embedded computer systems, a massively parallel computer system, and/or a cloud computer system.

The computer system 950 includes a processor 908 (e.g., a processor core, a microprocessor, a computing device, etc), a main memory 910 and a static memory 912, which communicate with each other via a bus 914. The machine 950 may further include a display unit 916 that may comprise a touch-screen, or a liquid crystal display (LCD), or a light emitting diode (LED) display, or a cathode ray tube (CRT). As shown, the computer system 950 also includes a human input/output (I/O) device 918 (e.g., a keyboard, an alphanumeric keypad, etc), a pointing device 920 (e.g., a mouse, a touch screen, etc), a drive unit 922 (e.g., a disk drive unit, a CD/DVD drive, a tangible computer readable removable media drive, an SSD storage device, etc), a signal generation device 928 (e.g., a speaker, an audio output, etc), and a network interface device 930 (e.g., an Ethernet interface, a wired network interface, a wireless network interface, a propagated signal interface, etc).

The drive unit 922 includes a machine-readable medium 924 on which is stored a set of instructions (i.e., software, firmware, middleware, etc) 926 embodying any one, or all, of the methodologies described above. The set of instructions 926 also may reside, completely or at least partially, within the main memory 910 and/or within the processor 908. The network bus 914 of the network interface device 930 may provide a way to further transmit or receive the set of instructions 926.

A computer may include a machine to perform calculations automatically. A computer may include a machine that manipulates data according to a set of instructions. In addition, a computer may include a programmable device that performs mathematical calculations and logical operations, especially one that can process, store and retrieve large amounts of data very quickly.

It is to be understood that embodiments of this invention may be used as, or to support, a set of instructions executed upon some form of processing core (such as the CPU of a computer) or otherwise implemented or realized upon or within a machine- or computer-readable medium. A machine-readable medium includes any mechanism for storing or transmitting information in a form readable by a machine (e.g., a computer). For example, a machine-readable medium includes read-only memory (ROM); random access memory (RAM); magnetic disk storage media; optical storage media; flash memory devices; electrical, optical, acoustical, or any other type of media suitable for storing information.

A computer program product on a storage medium having instructions stored thereon/in may implement part or all of system 200. The system may use these instructions to control, or cause, a computer to perform any of the processes. The storage medium may include without limitation any type of disk including floppy disks, mini disks (MD's), optical disks, DVDs, CD-ROMs, micro-drives, and magneto-optical disks, ROMs, RAMs, EPROMs, EEPROMs, DRAMs, VRAMs, flash memory devices (including flash cards), magnetic or optical cards, nanosystems (including molecular memory ICs), RAID devices, remote data storage/archive/warehousing, or any type of media or device suitable for storing instructions and/or data.

Storing may involve putting or retaining data in a memory unit such as a storage medium. Retrieving may involve locating and reading data from storage. Delivering may involve carrying and turning over to the intended recipient. For example, information may be stored by putting data representing the information in a memory unit, for example. The system may store information by retaining data representing the information in a memory unit, for example. The system may retrieve the information and deliver the information downstream for processing. The system may retrieve a message such as an advertisement from an advertising exchange system, carried over a network, and turned over to a member of a target-group of members.

Stored on any one of the computer readable medium, system 200 may include software both to control the hardware of a general purpose/specialized computer or microprocessor and to enable the computer or microprocessor to interact with a human consumer or other mechanism utilizing the results of system 200. Such software may include without limitation device drivers, operating systems, and user applications. Ultimately, such computer readable medium further may include software to perform system 200.

Although the system may utilize the techniques in the online advertising context, the techniques also may be applicable in any number of different open exchanges where the open exchange offers products, commodities, or services for purchase or sale. Further, many of the features described herein may help data buyers and others to target users in audience segments more effectively. However, while data in the form of segment identifiers may be generally stored and/or retrieved, examples of the invention preferably do not require any specific personal identifier information (e.g., name or social security number) to operate.

The techniques described herein may be implemented in digital electronic circuitry, or in computer hardware, firmware, software recorded on a computer-readable medium, or in combinations of them. The system may implement the techniques as a computer program product, i.e., a computer program tangibly embodied in an information carrier, including a machine-readable storage device, for execution by, or to control the operation of, data processing apparatus, e.g., a programmable processor, a computer, or multiple computers. Any form of programming language may convey a written computer program, including compiled or interpreted languages. A system may deploy the computer program in any form, including as a stand-alone program or as a module, component, subroutine, or other unit recorded on a computer-readable medium and otherwise suitable for use in a computing environment. A system may deploy a computer program for execution on one computer or on multiple computers at one site or distributed across multiple sites and interconnected by a communication network.

A system may perform the methods described herein in programmable processors executing a computer program to perform functions disclosed herein by operating on input data and generating output. A system also may perform the methods by special purpose logic circuitry and implement apparatus as special purpose logic circuitry special purpose logic circuitry, e.g., an FPGA (field programmable gate array) or an ASIC (application-specific integrated circuit). Modules may refer to portions of the computer program and/or the processor/special circuitry that implements that functionality. An engine may be a continuation-based construct that may provide timed preemption through a clock that may measure real time or time simulated through language like scheme. Engines may refer to portions of the computer program and/or the processor/special circuitry that implements the functionality. A system may record modules, engines, and other purported software elements on a computer-readable medium. For example, a processing engine, a storing engine, a retrieving engine, and a delivering engine each may implement the functionality of its name and may be recorded on a computer-readable medium.

Processors suitable for the execution of a computer program include, by way of example, both general and special purpose microprocessors, and any processors of any kind of digital computer. Generally, a processor may receive instructions and data from a read-only memory or a random access memory or both. Essential elements of a computer may be a processor for executing instructions and memory devices for storing instructions and data. Generally, a computer also includes, or may be operatively coupled to receive data from or transfer data to, or both, mass storage devices for storing data, e.g., magnetic, magneto-optical disks, or optical disks. Information carriers suitable for embodying computer program instructions and data include all forms of non-volatile memory, including by way of example semiconductor memory-devices, e.g., EPROM, EEPROM, and flash memory devices; magnetic disks, e.g., internal hard disks or removable disks; magneto-optical disks; and CD-ROM and DVD-ROM disks. A system may supplement a processor and the memory by special purpose logic circuitry and may incorporate the processor and the memory in special purpose logic circuitry.

To provide for interaction with a user, the techniques described herein may be implemented on a computer having a display device, e.g., a CRT (cathode ray tube) or LCD (liquid crystal display) monitor, for displaying information to the user and a keyboard and a pointing device, e.g., a mouse or a trackball, by which the user provides input to the computer (e.g., interact with a user interface element, for example, by clicking a button on such a pointing device). Other kinds of devices may be used to provide for interaction with a user as well; for example, feedback provided to the user includes any form of sensory feedback, e.g., visual feedback, auditory feedback, or tactile feedback; and input from the user may be received in any form, including acoustic, speech, or tactile input.

The techniques described herein may be implemented in a distributed computing system that includes a back-end component, e.g., as a data server, and/or a middleware component, e.g., an application server, and/or a front-end component, e.g., a client computer having a graphical user interface and/or a Web browser through which a user interacts with an implementation of the invention, or any combination of such back-end, middleware, or front-end components. A system may interconnect the components of the system by any form or medium of digital data communication, e.g., a communication network. Examples of communication networks include a local area network (“LAN”) and a wide area network (“WAN”), e.g., the Internet, and include both wired and wireless networks.

The computing system may include clients and servers. A client and server may be generally remote from each other and typically interact over a communication network. The relationship of client and server arises by virtue of computer programs running on the respective computers and having a client-server relationship to each other. One of ordinary skill recognizes any or all of the foregoing implemented and described as computer readable media.

In the above description, numerous details have been set forth for purpose of explanation. However, one of ordinary skill in the art will realize that a skilled person may practice the invention without the use of these specific details. In other instances, the disclosure may present well-known structures and devices in block diagram form to avoid obscuring the description with unnecessary detail. In other words, the details provide the information disclosed herein merely to illustrate principles. A skilled person should not construe this as limiting the scope of the subject matter of the terms of the claims. On the other hand, a skilled person should not read the claims so broadly as to include statutory and nonstatutory subject matter since such a construction is not reasonable. Here, it would be unreasonable for a skilled person to give a scope to the claim that is so broad that it makes the claim non-statutory. Accordingly, a skilled person is to regard the written specification and figures in an illustrative rather than a restrictive sense. Moreover, a skilled person may apply the principles disclosed to achieve the advantages described herein and to achieve other advantages or to satisfy other objectives, as well.

What is claimed is:

1. A method to target an online audience for advertisement in an advertising exchange system, the method comprising:
processing, in an advertising exchange system, at least one request to delivery at least one message over a network, wherein the advertising exchange system provides a marketplace for a plurality of independent entities;
storing an audience segment for a first entity in the advertising exchange system, wherein the audience segment identifies a population of visitors to one or more network locations of the first entity that form a target-group of members based on activity of the visitors at the first entity;
retrieving, in the advertising exchange system, the audience segment for a second entity; and
delivering, in response to the request, a message from the advertising exchange system to the target-group of members on behalf of the second entity by using the audience segment to target the target-group of members.

2. The method of claim 1, wherein:
the at least one request to delivery at least one message over a network is from the first entity and the message from the advertising exchange system is delivered to one or more network locations of the second entity.

3. The method of claim 1, wherein:
the at least one request to delivery at least one message over a network is from an entity other than the first entity and the message from the advertising exchange system is delivered to one or more network locations of the second entity.

4. The method of claim 3, wherein:
the at least one request to delivery at least one message over a network is from the second entity and the message from the advertising exchange system is delivered to one or more network locations of the second entity.

5. The method of claim 3, wherein:
the at least one request to delivery at least one message over a network is from the first entity and the message from the advertising exchange system is delivered to one or more network locations of a third entity.

6. A computer readable medium containing executable instructions stored thereon, which, when executed in a computer, cause computer to target an online audience for advertisement in an advertising exchange system, the instructions for:
processing, in an advertising exchange system, at least one request to delivery at least one message over a network, wherein the advertising exchange system provides a marketplace for a plurality of independent entities;
storing an audience segment for a first entity in the advertising exchange system, wherein the audience segment identifies a population of visitors to one or more network locations of the first entity that form a target-group of members based on activity of the visitors at the first entity;
retrieving, in the advertising exchange system, the audience segment for a second entity; and
delivering, in response to the request, a message from the advertising exchange system to the target-group of members on behalf of the second entity by using the audience segment to target the target-group of members.

7. The computer readable medium of claim 6, wherein:
the at least one request to delivery at least one message over a network is from the first entity and the message from the advertising exchange system is delivered to one or more network locations of the second entity.

8. The computer readable medium of claim 6 wherein:
the at least one request to delivery at least one message over a network is from an entity other than the first entity and the message from the advertising exchange system is delivered to one or more network locations of the second entity.

9. The computer readable medium of claim 8, wherein,
the at least one request to delivery at least one message over a network is from the second entity and the message from the advertising exchange system is delivered to one or more network locations of the second entity.

10. The computer readable medium of claim 8, wherein:
the at least one request to delivery at least one message over a network is from the first entity and the message from the advertising exchange system is delivered to one or more network locations of a third entity.

11. A system to target an online audience for advertisement in an advertising exchange system, wherein the advertising exchange system provides a marketplace for a plurality of independent entities, the system comprising:
at least one server comprising at least one processor and memory, comprising:
storage to store an audience segment for a first entity in the advertising exchange system, wherein the audience segment identifies a population of visitors to one or more network locations of the first entity that form a target-group of members based on activity of the visitors at the first entity;
a processing engine to process at least one request to delivery at least one message over a network, to retrieve, in the advertising exchange system, the audience segment for a second entity, and to deliver, in response to the request, a message from the advertising exchange system to the target-group of members on behalf of the second entity by using the audience segment to target the target-group of members.

12. The system of claim 11, where the at least one request to delivery at least one message over a network is from the first entity and the message from the advertising exchange system is delivered to one or more network locations of the second entity.

13. The system of claim 11, where the at least one request to delivery at least one message over a network is from an entity other than the first entity and the message from the advertising exchange system is delivered to one or more network locations of the second entity.

14. The system of claim 13, where the at least one request to delivery at least one message over a network is from the second entity and the message from the advertising exchange system is delivered to one or more network locations of the second entity.

15. The system of claim 13, where the at least one request to delivery at least one message over a network is from the first entity and the message from the advertising exchange system is delivered to one or more network locations of a third entity.
